(19) United States
(12) Patent Application Publication
(10) Pub. No.: US 2024/0258022 A1
(43) Pub. Date: Aug. 1, 2024

(54) ELECTROMAGNETIC DEVICE PROVIDED WITH COIL CASE

(71) Applicant: FANUC CORPORATION, Yamanashi (JP)

(72) Inventor: Tomokazu YOSHIDA, Yamanashi (JP)

(21) Appl. No.: 18/560,491

(22) PCT Filed: May 20, 2021
(86) PCT No.: PCT/JP2021/019260

§ 371 Date: Nov. 13, 2023

(51) Int. Cl. H01F 27/30; H01F 27/26; H01F 27/32

(52) U.S. Cl. CPC H01F 27/306; H01F 27/266; H01F 27/325

(57) ABSTRACT

The present invention prevents a coil case from being mispositioned in the radial direction of a coil body. A core body (5) of an electromagnetic device (6) includes an outer peripheral iron core (20) and at least three iron cores (41 to 44). The electromagnetic device further includes coils (51 to 54) mounted to the iron cores and coil cases (61 to 64). Fitting parts (70 and 80) for fitting the core body and the coil cases to each other are formed on the core body and each of the coil cases.

### FIELD

The present invention relates to an electromagnetic device, such as a reactor or transformer, which has a coil case.

### BACKGROUND

In recent years, electromagnetic devices comprising a core body including an outer peripheral iron core and a plurality of iron cores arranged inside the outer peripheral iron core have been developed. Coils are wound around each of the plurality of iron cores. There is known a technology while coils are housed in coil cases, coils are assembled with an electromagnetic device so as to insulate between the core body and the coils. Refer to, for example, Patent Literature 1 (Japanese Unexamined Patent Publication (Kokai) No. 2019-004126) and Patent Literature 2 (Japanese Unexamined Patent Publication (Kokai) No. 2019-016711).

### CITATION LIST

### Patent Literature

[PTL 1] Japanese Unexamined Patent Publication (Kokai) No. 2019-004126
[PTL 2] Japanese Unexamined Patent Publication (Kokai) No. 2019-016711

### SUMMARY

### Technical Problem

However, when coil cases are used, the coil cases may be displaced in the radial direction of the core body. As a result, it may be difficult to accurately and easily assemble the electromagnetic device.

Therefore, there is a demand for an electromagnetic device in which the coil cases are not displaced in the radial direction of the core body.

### Solution to Problem

According to a first aspect of the present disclosure, there is provided an electromagnetic device comprising a core body, wherein the core body comprises an outer peripheral iron core composed of a plurality of outer peripheral iron core portions, and at least three iron cores joined with the plurality of outer peripheral iron core portions, the electromagnetic device further comprising coils which are installed on the at least three iron cores, and coil cases which at least partially cover each of the at least three iron cores to insulate them from the coils, wherein mating parts by means of which the core body and the coil cases are mated with each other are formed on each of the core body and the coil case.

### Advantageous Effects of Invention

In the first aspect, the coil cases and the core body are joined together by the mating parts. Thus, once joined, the coil cases will not be displaced in the radial direction of the core body. Therefore, the electromagnetic device can accurately and easily be assembled.

The objects, characteristics, and advantages of the present invention will be clarified from the following description of the embodiments in conjunction with the accompanying drawings.

### BRIEF DESCRIPTION OF DRAWINGS

FIG. 1A is a cross-sectional view of a core body included in an electromagnetic device according to a first embodiment.

FIG. 1B is a perspective view of the electromagnetic device shown in FIG. 1A.

FIG. 2A is a perspective view of a coil case as viewed from the radially inner side of the electromagnetic device.

FIG. 2B is a perspective view of a coil case as viewed from the radially outer side of the electromagnetic device.

FIG. 2C is a partial top view of an electromagnetic device.

FIG. 2D is a partial top view of an electromagnetic device of the prior art.

FIG. 3 is a partial perspective view of an electromagnetic device.

FIG. 4A is a first partial cross-sectional view of the electromagnetic device of the present disclosure.

FIG. 4B is a second partial cross-sectional view of the electromagnetic device of the present disclosure.

FIG. 4C is a third partial cross-sectional view of the electromagnetic device of the present disclosure.

FIG. 5 is another perspective view of a coil case similar to FIG. 2B.

FIG. 6 is a view showing the magnetic flux density distribution of the outer peripheral iron core portions of the present disclosure.

FIG. 7 is a cross-sectional view of a core body included in an electromagnetic device according to a second embodiment.

FIG. 8A is a cross-sectional view of a core body included in an electromagnetic device according to another embodiment.

FIG. 8B is a cross-sectional view of a core body included in an electromagnetic device according to yet another embodiment.

### DESCRIPTION OF EMBODIMENTS

The embodiments of the present invention will be described below with reference to the attached drawings. In the drawings, corresponding constituent elements are assigned common reference signs.

Though a three-phase reactor is mainly described as an example of an electromagnetic device in the following discussion, application of the present disclosure is not limited to three-phase reactors, but is widely applicable to multi-phase reactors which require constant inductance in each phase, and is also applicable to transformers. Furthermore, a reactor according to the present disclosure is not limited to being provided on the primary side and secondary side of inverters in industrial robots and machine tools, and can be applied to various devices.

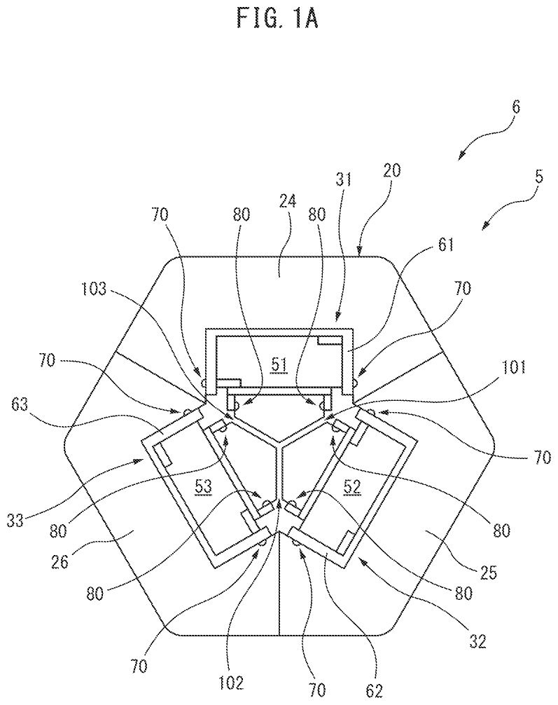

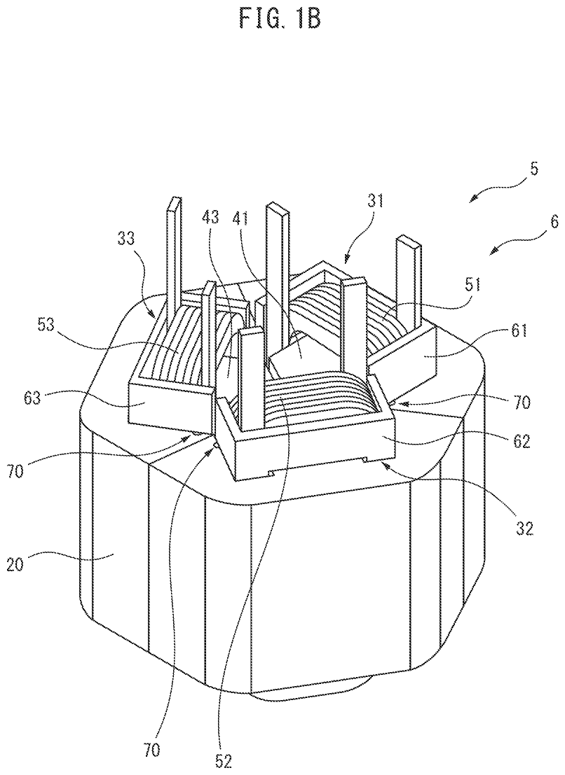

FIG. 1A is a cross-sectional view of a core body included in an electromagnetic device according to a first embodiment. FIG. 1B is a perspective view of the electromagnetic device shown in FIG. 1A. As shown in FIGS. 1A and 1B, the core body 5 of the electromagnetic device 6 comprises an outer peripheral iron core 20 and three iron core coils 31 to 33 arranged inside the outer peripheral iron core 20. In FIG. 1, iron core coils 31 to 33 are arranged inside the substantially hexagonal outer peripheral iron core 20. These iron core coils 31 to 33 are arranged at regular intervals in the circumferential direction of the core body 5.

Note that the outer peripheral iron core 20 may have other rotationally symmetrical shapes, such as a circular shape. Furthermore, the number of iron core coils should be a multiple of three, and in that case, the reactor as the electromagnetic device 6 can be used as a three-phase reactor.

As can be seen from the drawings, each of the iron core coils 31 to 33 includes iron cores 41 to 43 extending only in the radial direction of the outer peripheral iron core 20, and coils 51 to 53 installed on the iron cores. At least three coils 51 to 53 are housed in coil cases 61 to 63, respectively. The coil cases 61 to 63 are preferably formed from a non-magnetic material such as a resin.

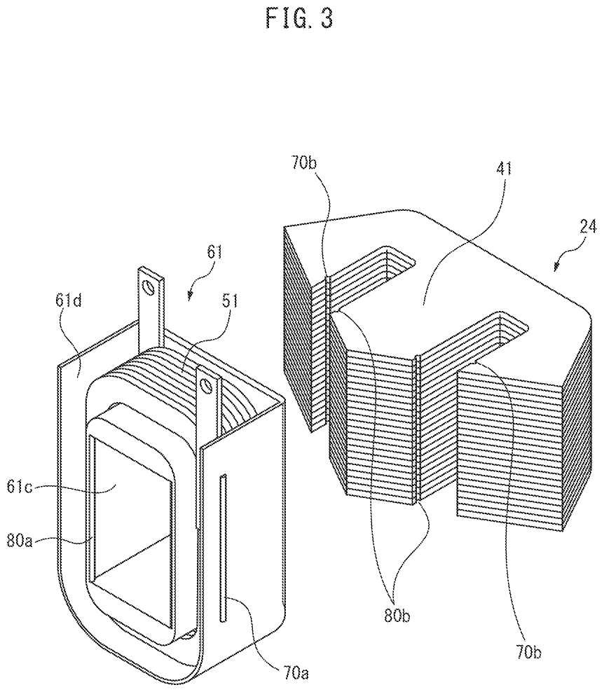

The outer peripheral iron core 20 is composed of a plurality of, for example, three, outer peripheral iron core portions 24 to 26 divided in the circumferential direction. The outer peripheral iron core portions 24 to 26 are integrally formed with the iron cores 41 to 43, respectively. As can be seen from FIG. 3, which is described later, the outer peripheral iron core portions 24 to 26 and the iron cores 41 to 43 are formed by stacking a plurality of magnetic plates, such as iron plates, carbon steel plates, electromagnetic steel plates, or formed from powder iron cores. When the outer peripheral iron core 20 is composed of a plurality of outer peripheral iron core portions 24 to 26 in this manner, the outer peripheral iron core 20 can be easily produced even if the outer peripheral iron core 20 is large. Note that the number of iron cores 41 to 43 and the number of outer peripheral iron core portions 24 to 26 need not necessarily match.

Furthermore, the radially inner ends of the iron cores 41 to 43 are positioned near the center of the outer peripheral iron core 20. In the drawings, the radially inner ends of the iron cores 41 to 43 converge toward the center of the outer peripheral iron core 20, with a tip angle of approximately 120 degrees. The radially inner ends of the iron cores 41 to 43 are separated from each other via magnetically couplable gaps 101 to 103.

In other words, the radially inner end of the iron core 41 and the radially inner ends of the two adjacent iron cores 42, 43 are separated from each other via the gaps 101, 103, respectively. The same applies to the other iron cores 42 and 43. The dimensions of gaps 101 to 103 are equal to each other.

In this manner, in the configuration shown in FIG. 1A, the core body 5 can be made lightweight and simple because a central iron core located in the center of the core body 5 is unnecessary. Furthermore, since the three iron core coils 31 to 33 are surrounded by the outer peripheral iron core 20, the magnetic field generated from the coils 51 to 53 does not leak outside the outer peripheral iron core 20. Since the gaps 101 to 103 can be provided at an arbitrary thickness at low cost, it is advantageous in terms of design compared to reactors of conventional structure.

In the core body 5 of the present disclosure, the difference in the magnetic path length between the phases is reduced as compared to an electromagnetic device having a conventional structure. Thus, in the present disclosure, inductance imbalance caused by a difference in magnetic path length can be reduced.

As can be seen with reference to FIG. 1B, each of the coils 51 to 53 installed on the iron cores 41 to 43 is a flat wire coil formed by winding a flat wire at least once. Naturally, the coils 51 to 53 (54) may be coils other than flat wire coils.

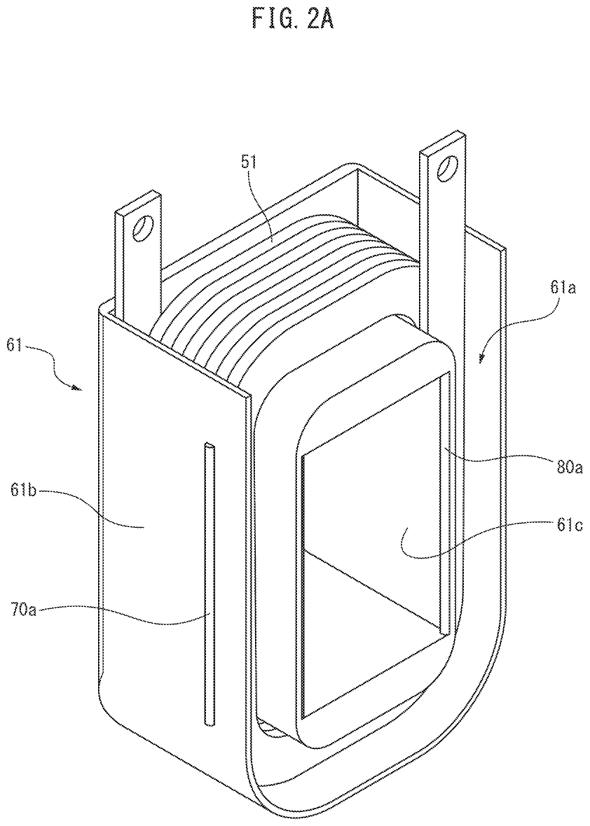

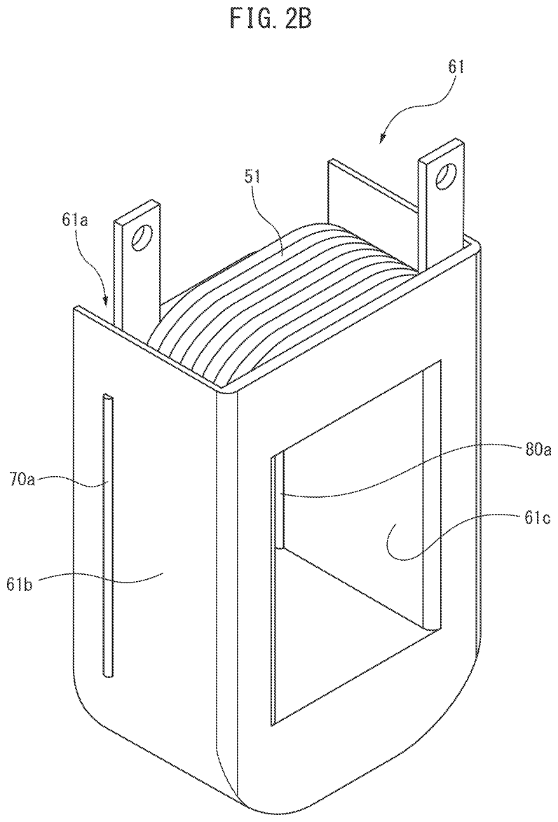

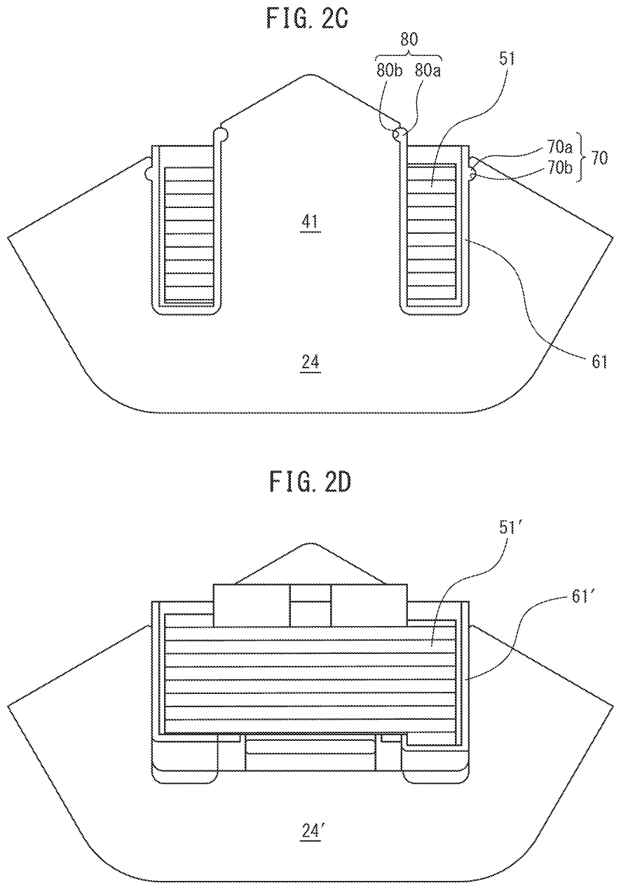

FIG. 2A is a perspective view of a coil case as viewed from radially inside the electromagnetic device, and FIG. 2B is a perspective view of the coil case as viewed from radially outside of the electromagnetic device. In these drawings and other drawings to be described later, only the coil case 61 is shown as a representation, but the other coil cases 62, 63, (64) are assumed to have the same configuration. The coil case 61 has a housing 61b with an open upper surface and an open radially inner surface, and a hollow projecting part 61c protruding radially inwardly from the radially outer end surface of the housing 61b.

The space between the housing 61b and the hollow projecting part 61c serves as a coil housing 61a having a shape suitable for housing the coil 51. As will be described later, the hollow portion of the hollow projecting part 61c has a shape suitable for receiving the iron core 41.

As shown in FIGS. 2A and 2B, a convex part 70a as a first mating part 70 is formed in a portion of the outer peripheral surface of the housing 61b facing the outer peripheral iron core portion 24. Likewise, a convex part 80a as a second mating part 80 is formed in a portion of the inner peripheral surface of the hollow projecting part 61c facing the iron core 41. In FIGS. 2A and 2B, two convex parts 70a and two convex parts 80a are formed for one coil case 61.

As can be seen from the drawings, these convex parts 70a have a semi-circular cross-section and extend parallel to the axial direction of the electromagnetic device 6. The length of the convex part 70a formed on the outer peripheral surface of the housing 61b is approximately equal to the height of the corresponding coil 51, and the length of the convex part 80a formed on the inner peripheral surface of the hollow projecting part 61c is approximately equal to the height of the opening of the corresponding coil 51. Alternatively, the convex parts 70a, 80a may extend at least partially parallel to the axial direction of the electromagnetic device 6.

FIG. 2C is a partial top view of the electromagnetic device. As shown in FIG. 2C, a concave part 70b as a first mating part 70 is formed in the outer peripheral iron core portion 24. The concave part 70b mates with a convex part 70a formed on the outer peripheral surface of the coil housing 61a. Likewise, a concave part 80b as a second mating part 80 is formed in the iron core 41. The concave part 80b mates with the convex part 80a formed on the inner peripheral surface of the hollow projecting part 61c.

As can be seen from FIG. 2C, the second mating part 80 is closer to the center of the core body 5 than the first mating part 70. In other words, the distance between the first mating part 70 and the center of the electromagnetic device 6 is different than the distance between the second mating part 80 and the center of the electromagnetic device 6.

FIG. 3 is a partial perspective view of an electromagnetic device. As shown in FIG. 3, the coil case 61 containing the coil 51 is moved toward the outer peripheral iron core portion 24. As a result, the iron core 41 integrated with the outer peripheral iron core portion 24 is inserted into the hollow projecting part 61c of the coil case 61.

Since the coil case 61 is made of resin, the inner and outer peripheral surfaces of the coil case 61 are temporarily bent during insertion. When the convex parts 70a and 80a mate with the concave parts 70b and 80b, respectively, the inner and outer peripheral surfaces of the coil case 61 return to their original state. Specifically, the first mating part 70 and the second mating part 80 are each brought into snap engagement. As a result, the coil 51 can be installed on the iron core 41. The other coils 52, 53 are likewise installed on the iron cores 42, 43 of the outer peripheral iron core portions 25, 26, respectively, after being accommodated in the corresponding coil cases 62, 63. The outer peripheral iron core portions 24 to 26 are then assembled together to form the electromagnetic device 6 shown in FIG. 1B.

As a result, in the present disclosure, the coil cases 61 to 63 and the core body 5 are joined together by the mating parts 70, 80. Thus, once joined, the coil cases 61 to 63 will not be displaced in the radial direction of the core body 5. Therefore, the electromagnetic device 6 can be accurately and easily assembled.

Furthermore, as described with reference to FIG. 2C, when the distance between the first mating part 70 and the center of the electromagnetic device 6 is different than the distance between the second mating part 80 and the center of the electromagnetic device 6, the coil cases 61 to 63 can be better prevented from being displaced in the radial direction of the core body 5.

FIG. 2D is a partial top view of an electromagnetic device of the prior art. In FIG. 2D, the mating parts 70, 80 are not formed. As a result, the coil case 61′ of the prior art may be displaced in the radial direction. The present disclosure overcomes such problems as described above.

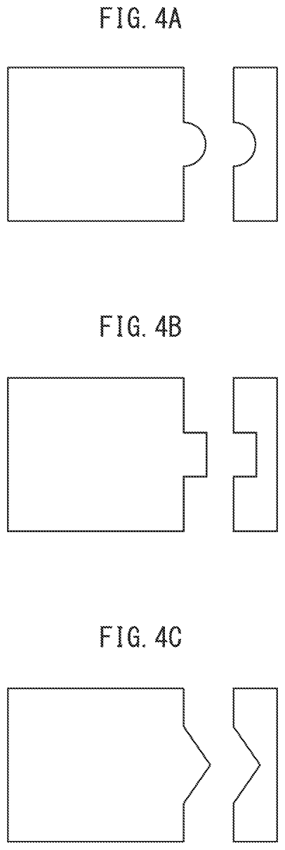

In FIG. 2A and the like, the convex part 70a is formed on the coil case 61 and the concave part 70b is formed on the outer peripheral iron core portion 24. However, as shown in FIGS. 4A to 4C, which are partial cross-sectional views of the electromagnetic device in the present disclosure, the concave part 70b may be formed on the coil case 61 and the convex part 70a may be formed on the outer peripheral iron core portion 24. The same is true for the second mating part 80.

In FIG. 2A and the like, the convex part 70a has a semicircular cross section. However, the cross-section of the convex part 70a is not limited to a semi-circular shape, and may be, for example, rectangular as shown in FIG. 4B or triangular as shown in FIG. 4C. As a matter of course, the concave part 70b has a shape corresponding to that of the convex part 70a.

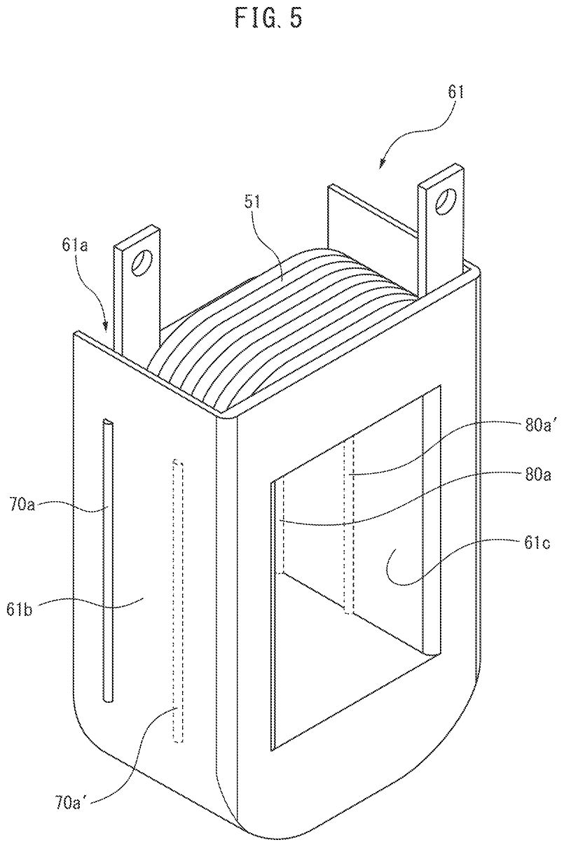

FIG. 5 is another perspective view of a coil case similar to FIG. 2B. In FIG. 5, in addition to the convex part 70a described above, an additional convex part 70a′ extending parallel to the convex part 70a is indicated by a dashed line on the outer peripheral surface of the housing 61b. Further, a convex part 80a similar to that in FIG. 2B is indicated by a dashed line, and an additional convex part 80a′ extending parallel to the convex part 80a is indicated by a dashed line on the inner peripheral surface of the hollow projecting part 61c. As a matter of course, when an additional convex part 70a′ and/or additional convex part 80a′ are formed, a corresponding additional concave part 70b′ and/or additional concave part 80b′ can be formed on the outer peripheral iron core portion 24 and the iron core 41.

As can be inferred from FIG. 5, only the convex part 70a and the additional convex part 70a′ may be formed on the housing 61b, thereby providing two first mating parts 70 on one side of the outer peripheral surface of the housing 61b. Likewise, only the convex part 80a and the additional convex part 80a′ may be formed into the hollow projecting part 61c, thereby providing two second mating parts 80 on one side of the inner peripheral surface of the hollow projecting part 61c. As can be interpreted from FIG. 5, only the convex part 70a may be formed in the housing 61a, whereby the core body 5 and the coil case 61 may be fitted with only the first mating part 70. Likewise, though not shown in the drawings, only the convex part 80a may be formed in the hollow projecting part 61c, whereby the core body 5 and the coil case 61 are fitted together only with the second mating part 80. In such a case, concave parts corresponding to the convex parts 70a and 70a′ described above or convex parts corresponding to the concave parts 80a and 80a′ described above are formed. It can be understood that even in such a case, the same effects as described above are obtained.

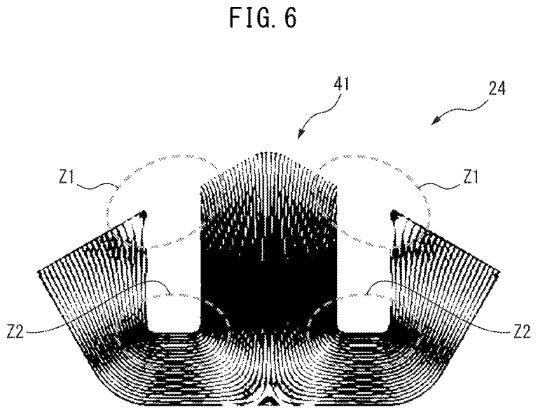

FIG. 6 is a view showing magnetic flux density distribution of the outer peripheral iron core portions of the present disclosure. For the sake of conciseness, FIG. 6 shows the magnetic flux density distribution of only the outer peripheral iron core portion 24 when the electromagnetic device 6 as a reactor is driven. The other outer peripheral iron core portions 25, 26 also exhibit the same magnetic flux density distribution as the outer peripheral iron core portion 24.

In FIG. 6, the magnetic flux density is small (illustrated in region Z1) in both end parts of the outer peripheral iron core portion 24 in the circumferential direction of the electromagnetic device 6, i.e., in both end parts adjacent to the radially inner ends of the iron core 41, as well as the radially inner ends of the iron core 41, and the vicinities thereof. In connection thereto, the magnetic flux density is high (illustrated in region Z2) in the radial outer ends of the iron core 41, i.e., the central portions of the inner circumferential side of the outer peripheral iron core portion 24 in the circumferential direction of the electromagnetic device 6, and the vicinities thereof.

When the mating parts 70, 80 are formed in locations where the magnetic flux density is high, the core body 5 may be heated, and may cause noise. In the present disclosure, the mating parts 70, 80 are formed in the locations described above where the magnetic flux density is low. Thus, even if the mating parts 70, 80 are formed, heating of the core body 5 or the occurrence of noise can be suppressed.

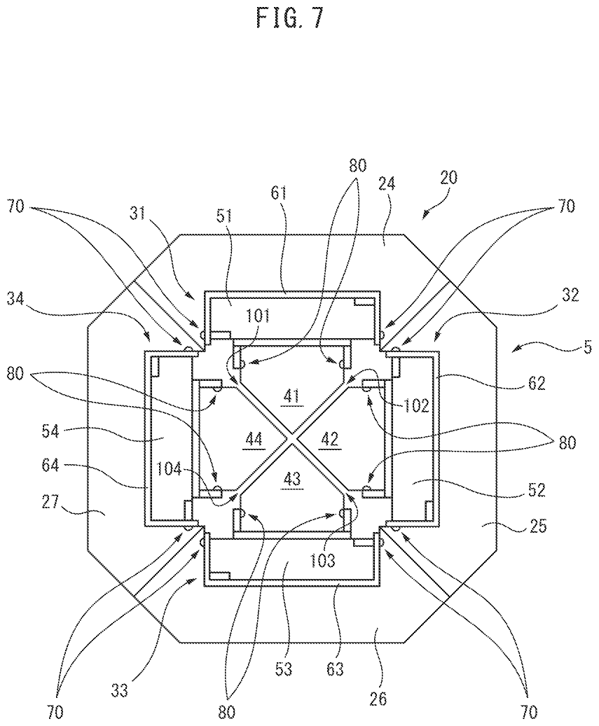

FIG. 7 is a top view of the core body of an electromagnetic device of another embodiment. The core body 5 shown in FIG. 7 comprises a substantially octagonal outer peripheral iron core 20 and four iron core coils 31 to 34, which are arranged inside the outer peripheral iron core 20 and which are identical to those described above. These iron core coils 31 to 34 are arranged at equal intervals in the circumferential direction of the core body 5. Furthermore, it is preferable that the number of iron cores be an even number of four or more, whereby the electromagnetic device 6 as a reactor can be used as a single-phase reactor.

As can be understood from the drawings, the outer peripheral iron core 20 is constituted by the four outer peripheral iron core portions 24 to 27, which are divided in the circumferential direction. Each of the iron core coils 31 to 34 include an iron core 41 to 44 extending in the radial direction and a coil 51 to 54 installed on the iron core. Further, the radially outer ends of each of the iron cores 41 to 44 are integrally formed with the respective outer peripheral iron core portion 21 to 24. Note that the number of the iron cores 41 to 44 need not necessarily match the number of the outer peripheral iron core portions 24 to 27.

Further, the radially inner end of each of the iron cores 41 to 44 is positioned near the center of the outer peripheral iron core 20. In FIG. 7, the radially inner ends of the iron cores 41 to 44 converge toward the center of the outer peripheral iron core 20, with a tip angle of 90 degrees. Further, the radially inner ends of the iron cores 41 to 44 are spaced apart from each other via magnetically couplable gaps 101 to 104.

In FIG. 7, each of the at least three coils 51 to 54 is housed in a coil case 61 to 64 identical to those described above. Further, the first mating part 70 and the second mating part 80 are formed on the coil cases 61 to 64 and the core body 5 in the same manner as described above. The coil cases 61 to 64 and the core body 5 are mated to each other by the mating parts 70, 80, whereby the coil cases 61 to 64 do not become displaced in the radial direction of the core body 5. Thus, it would be understood that the same effects as described above can be obtained.

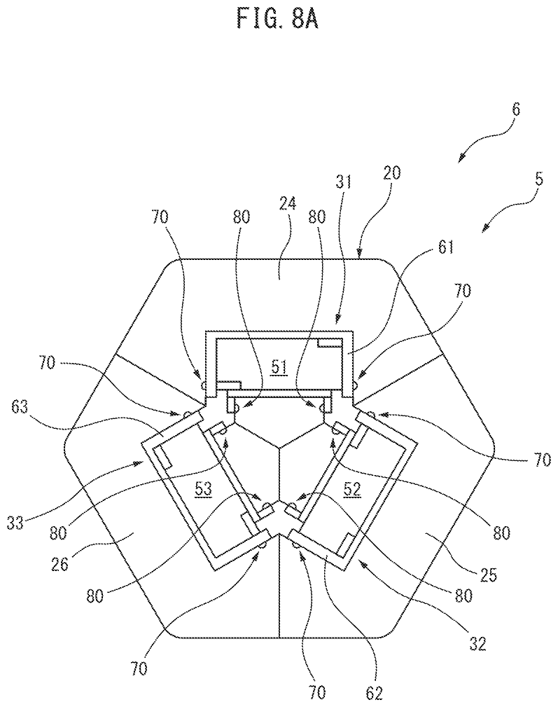

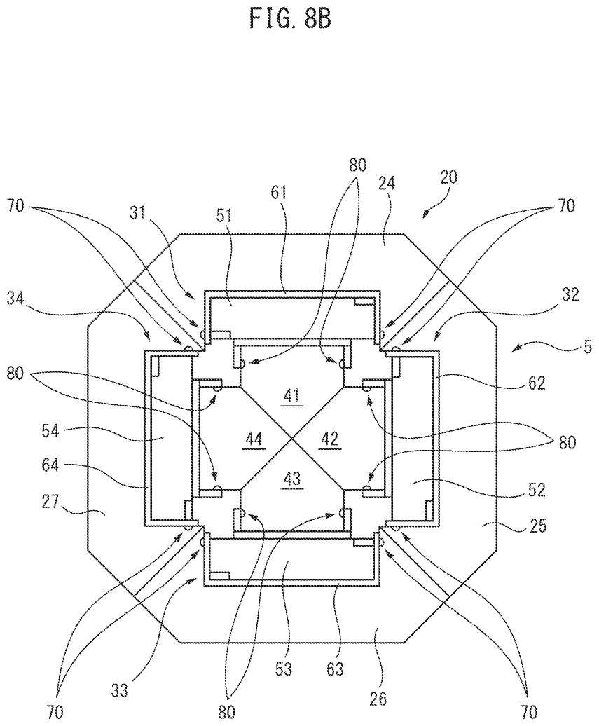

Further, FIGS. 8A and 8B are cross-sectional views of a core body included in an electromagnetic device based on another embodiment. In these drawings, a transformer is shown as an example of the electromagnetic device 6. Since FIGS. 8A and 8B are identical to FIGS. 1A and 7, respectively, redundant explanation of previously described members has been omitted. In FIGS. 8A and 8B, the radially inner ends of the iron cores 41 to 43 (44) abut against the radially inner ends of the adjacent iron cores 41 to 43 (44). Thus, the electromagnetic device 6 shown in FIGS. 8A and 8B does not include gaps 101 to 103 (104).

In FIGS. &A and 8B, the first mating part 70 and the second mating part 80 are formed on the coil cases 61 to 63 (64) and the core body S in the same manner as described above. Thus, it would be understood that even if the electromagnetic device 6 is a transformer, the same effects as described above can be obtained.

### Disclosure of the Aspects

According to a first aspect, there is provided an electromagnetic device (6), comprising a core body (5), wherein the core body comprises an outer peripheral iron core (20) composed of a plurality of outer peripheral iron core portions (24 to 27), and at least three iron cores (41 to 44) joined with the plurality of outer peripheral iron core portions, the electromagnetic device further comprising coils (51 to 54) which are installed on the at least three iron cores, and coil cases (61 to 64) which at least partially cover each of the at least three iron cores to insulate them from the coil, wherein mating parts (70, 80) by means of which the core body and the coil case are mated with each other are formed on each of the core body and the coil cases.

According to a second aspect, in the first aspect, the mating parts each comprise a concave part which is formed so as to extend at least partially parallel to an axial direction of the core body, and a convex part which mates with the concave part.

According to a third aspect, in the first or second aspect, the mating parts are each formed at least one of between an inner peripheral surface of the coil cases and the iron cores and between an outer peripheral surface of the coil cases and the outer peripheral iron core.

According to a fourth aspect, in the first or second aspect, the mating parts each comprise a first mating part formed between an outer peripheral surface of the coil cases and the iron cores, and a second mating part formed between an inner peripheral surface of the coil cases and the outer peripheral iron core, and
a distance between the first mating part and a center of the electromagnetic device is different from a distance between the second mating part and the center of the electromagnetic device.

According to a fifth aspect, in any one of the first through fourth aspects, a number of the at least three iron cores is a multiple of three.

According to a sixth aspect, in any one of the first through fourth aspects, a number of the at least three iron cores is an even number of four or more.

### Effects of the Aspects

In the first aspect, the coil cases and core body are joined together by the mating parts. Thus, once joined, the coil cases will not be displaced in the radial direction of the core body. Therefore, the electromagnetic device can be accurately and easily assembled.

In the second and third aspects, the effects described above can be achieved with a simple structure.

In the fourth aspect, positional displacement of the coil cases in the radial direction of the electromagnetic device can be suppressed.

In the fifth aspect, the electromagnetic device can be used as a three-phase reactor.

In the sixth aspect, the electromagnetic device can be used as a single-phase reactor.

Though the embodiments of the present invention have been described above, a person skilled in the art would understand that various modifications and changes can be made without departing from the disclosed scope of the claims, which are described later.

### DESCRIPTION OF REFERENCE SIGNS

1. An electromagnetic device, comprising:
a core body, wherein
the core body comprises an outer peripheral iron core composed of a plurality of outer peripheral iron core portions, and at least three iron cores joined with the plurality of outer peripheral iron core portions, the electromagnetic device further comprising:
coils which are installed on the at least three iron cores, and
coil cases which at least partially cover each of the at least three iron cores to insulate them from the coils, wherein
mating parts by means of which the core body and the coil cases are mated with each other are formed on each of the core body and the coil case.

2. The electromagnetic device according to claim 1, wherein the mating parts each comprise a concave part which is formed so as to extend at least partially parallel to an axial direction of the core body, and a convex part which mates with the concave part.

3. The electromagnetic device according to claim 1, wherein the mating parts are each formed at least one of between an inner peripheral surface of the coil cases and the iron cores and between an outer peripheral surface of the coil cases and the outer peripheral iron core.

4. The electromagnetic device according to claim 1, wherein the mating parts each comprise a first mating part formed between an outer peripheral surface of the coil cases and the iron cores, and a second mating part formed between an inner peripheral surface of the coil cases and the outer peripheral iron core, and
a distance between the first mating part and a center of the electromagnetic device is different from a distance between the second mating part and the center of the electromagnetic device.

5. The electromagnetic device according to claim 1, wherein a number of the at least three iron cores is a multiple of three.

6. The electromagnetic device according to claim 1, wherein a number of the at least three iron cores is an even number of four or more.
